(19) United States
(12) Patent Application Publication
(10) Pub. No.: US 2003/0051611 A1
(43) Pub. Date: Mar. 20, 2003

(54) Dough perforator method and use

(76) Inventor: Sail Katta Reddy, Urbana, IL (US)

Correspondence Address: SAIL KATTA REDDY, 1010 N. DIVISION STREET, URBAN, IL, 61801, US

(21) Appl. No.: 09/955,671

(22) Filed: Sep. 19, 2001

(51) Int. Cl. A23N 1/00

(52) U.S. Cl. 99/537

(57) ABSTRACT

An apparatus and two methods which quickly provides several perforations on a dough layer. An apparatus according to the invention includes a circular shaped top portion with its bottom surface having several measured threaded holes in a fixed pattern to provide grip for several nail like objects arranged in a fixed pattern. These nail like objects tips pointed either downwards or upwards means to provide perforations on a dough layer. Structure such as handles are provided to aid in lifting and pushing the tool during and after operation. Two corresponding methods of operations are also disclosed.

### CROSS REFERENCE TO RELATED APPLICATIONS

Not applicable

### STATEMENT REGARDING FEDERALLY SPONSORED RESEARCH AND DEVELOPMENT

Not applicable

### REFERENCE TO MICROFICHE

Not applicable

### FIELD OF INVENTION

This invention relates to dough docker (hand tool) specifically used for providing air pockets in the dough prior to baking.

### BACKGROUND OF THE INVENTION

Pizza places are trying to provide a good quality pizza and a fastest service possible due to a very high competition in the present day market. Customers these days tend to go to a place where they can get a good quality food and a quick service.

In order to provide a quick service, one needs a fast cooking oven, a fast cooking pizza crust, a fast pizza maker and a fast server while maintaining a good quality food product.

Due to the yeast added in the dough for rising the dough to be soft, the dough or the pizza crust can bubble up while cooking due to the temperature changes that are favourable for the yeast to react with the sugar. These bubbles can deform the pizza, can get burnt and can push away the cheese and other toppings and at times burnt holes are left behind after cooked.

In order to avoid these air bubbles, pizza makers use all kinds of hand tools available in the market. The oldest one has a long tube of light weight with its one end curved and pointed so as to facilitate in bursting bubbles individually as the bubbles arise while cooking. This is a laborious method and a risksome method since one has to open the hot oven doors causing loss of heat, and one has to use the tool to burst the bubbles, the end result being end up with either burning ones hands or the pizza with holes in it. Therefore, this tool is not a very suitable tool indeed. Then there are other hand tools such as dough dockers which can be used on the dough before cooking. All the dough docker tools though serves the purpose of docking the dough, one has to use the tool more than once in order to ensure enough perforations since the size of the dockers are small to provide enough perforations in one attempt. The tougher the pizza dough, the greater the rolling of the docker tool. The bigger the pizza dough, the greater the rolling of the docker tool. Several repetition of the tool takes up more time, slows the process of making the pizza, can cause repetitive stress syndrome to the users hand(s), and at times even damaging the dough. This may lead to high labor cost. If the pizza maker is not tired by using the hand docker tools, he or she can use rest of the energy to do something else in pizza making process more efficiently and quickly as possible.

### DISCUSSION OF PRIOR ART

U.S. Pat. No. 5,591,470 issued January 1997 to inventor Bartley James sets forth a method and apparatus for docking a dough. This docker apparatus has plurality of pins protruding downwards for said carrier of rectangular martix pattern. This one is convenient for a high volume food processing operations but it takes up some space, dough gets stuck at times, noisy and expensive to buy. The apparatus has a complicated mechanisms and not suitable as a hand tool in the fast food pizza places.

Another such tool, automated pizza dockers disclosed in U.S. Pat. No. 4,573,388 includes a motor driven shaft with radially expanding spines for perforating the dough. Yet this machine is not suitable as a hand tool.

Another such apparatus for a high volume food processing operations would be a bread pricking machine having a combination with rotatable table and a revoluble pricking roller (U.S. Pat. No. 769,444).This tool is electrically operated and has its own disadvantages and not very suitable as a hand tool.

U.S. Pat. No. 6,194,017 issued Feb. 27, 2001 to inventors Woodward, et al explains an apparatus for dough punch and method and use. Structure such as the hinge is provided to lower the top portion toward the base portion. Holding and moving a long handle to operate a device and to repeatedly operate the handle may easily cause repetitive stress syndrome in the long run.

Hand docker tools such as heavy duty roller dockers that has either plastic or steel handle with stainless steel pins which are permanently embedded in a plastic core in a spiral fashion which revolves on an axle. These tools have less pins therefore one has to roll the docker back and forth several times depending on the size and texture of the dough layer in order to provide enough perforations.

Another such tool though it is lighter in weight with an easier moving capability, that too has to be used several times by holding the handles. Such roller pin dockers also have individual wheels or plastic pin units.

In order to conclude, all these hand tools are time and energy consuming which slows down the productivity, and also leading to a high degree repetitive stress syndrome to the users hands in the long run.

What is then needed is a low-cost alternative docking device which can be used with tow maintenance, potentially without a cost of operation such as consumption of electricity. A device that does not take up plenty of users energy, time and does not lead to too much repetitive stress syndrome. A device that provides fine perforations without damaging the dough. A perforating apparatus that has less mechanisms such as hinges, long handles that needs too much energy to operate the device. Further, users least amount of energy be used in operating a perforating device such that a user can provide much faster service in the process.

### SUMMARY OF THE PRESENT INVENTION

1. It is an object of the present invention to provide a pizza perforating device which is usable in a high volume fast food pizzarias where manual labor is involved.

2. It is a further object of the invention to provide fine perforations in the pizza crust prior to baking in order to create a high quality taste, texture and appearance of the pizza product.

3. It is a further object of my invention to provide a tool such that the overall weight of the tool itself does most of the work of perforating the dough layer just by placing the entire tool on the dough layer as necessary.

4. It is my further object of my invention to have a circular shaped tool since most of the pizza crusts are circular in shape.

5. It is a further object of my invention to provide a hand held perforating device with a minimum complicated working mechanisms involved.

6. It is a further object of my invention to provide several required perforations in a very less time possible.

7. It is a further object of my invention to provide a hand tool that makes no noise when used.

8. It is a further object of my present dough perforator hand tool that does not lead to too much of a repetitive stress syndrome.

9. It is a further object of my invention to provide a tool that can be used by turning upside down and do the same work of providing perforations.

Further objects and advantages of my invention will become apparent from a consideration of the drawings and ensuing description thereof.

### BRIEF DESCRIPTION OF THE DRAWINGS

FIG. 1 Showing a circularly shaped top portion and its top view.

FIG. 2 a top view of a circularly shaped top portion showing the two handles.

FIG. 3 showing a circularly shaped top portion with its bottom view having several threaded holes.

FIGS. 4 and 5 showing top end of the nail like object(s) with threads.

FIG. 6 showing a bottom end of the nail like object.

FIG. 7 is an entire view of the nail like object.

FIG. 8 Entire features of the dough perforator tool showing an upper circularly shaped top portion, 2 handles, underneath showing some of the nail like objects protruding downwards.

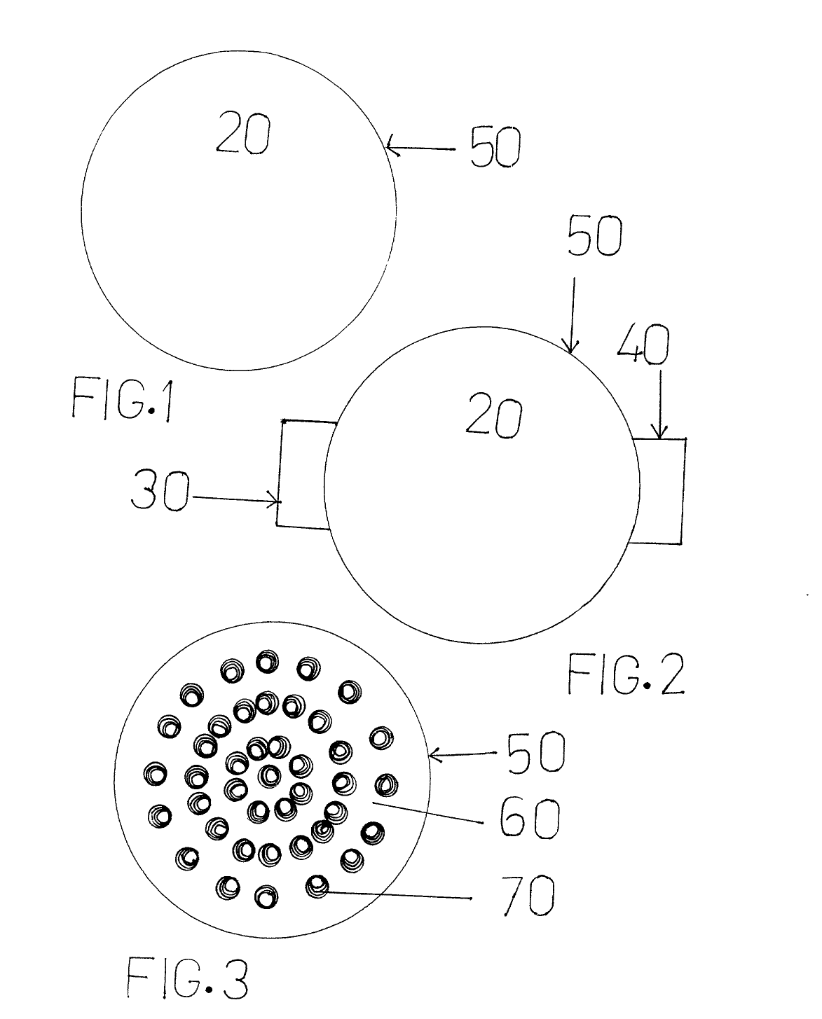

### REFERENCE NUMBERS

perforator apparatus assembly 10

circular shaped top portion 20

handles 30 & 40

circular rim 50

bottom surface 60

threaded holes 70

nail like objects 80

few threads 90

narrow & pointed ends 100

dough layer 110.

### DETAILED DESCRIPTION OF THE PREFERRED EMBODIMENT

The preferred embodiment of a dough perforator device assembly 10 is shown in FIG. 8. The preferred embodiment has a circular shaped top portion 20 can be made of any material having durable, sanitary, rust proof and non-stick, high temperature resistant qualities.

Weight of the circularly shaped top portion depends on the size of the tool made.

To the right and left sides of the circularly shaped top portion, handles 30 and 40 are facing opposite to each other, each said handle attached to the top upper side of the circular rim 50. Each handle preferably attached like an ear lobe wherin the size of the handles being suitable to place palms while applying additional pressure when necessary. The handles 30 and 40 can be made of any material as long as it has rust proof and durable strength. Said handles 30 and 40 are also a means to hold and carry the tool as necessary. From the experiments it was found that absence of handles made it inconvenient during the operation of the apparatus, eventhough one can use the tool without the help of the handles at times.

A bottom surface 60 of the circularly shaped top portion 20 are provided with a number of threaded holes 70. The said threaded holes 70 are arranged in a concentric ring fashion since the perforations provided on the dough in a circular fashion are more effective in providing even cooking and even escaping of the steam during cooking. The threaded holes 70 are found suitable since the nail like objects if damaged can be replaced very easily. Other methods of welding and molding can also be done to arrange the nail like objects which are known in th prior art.

The number, size and distance between the threaded holes 70 arranged in a fixed pattern.

The entire outerview of the said threaded holes 70 are arranged on the bottom surface 60 of the circular shaped top portion 20 shown in FIG. 3.

A number of nail like objects 80 means to provide perforations having a few threads 90 at top end as shown in the FIGS. 4 & 5.

Nail like objects 80 varies in size, number, & weight depending on the size of the tool made.

These nail like objects 80 having narrow & pointed ends 100 means to avoid the risk of dough getting stuck or damaged. The shape of the narrow and pointed end 100 shown in FIG. 6. Nail like objects 80 can be made of any material that is strong and flexible, rust proof, non stick and sanitary.

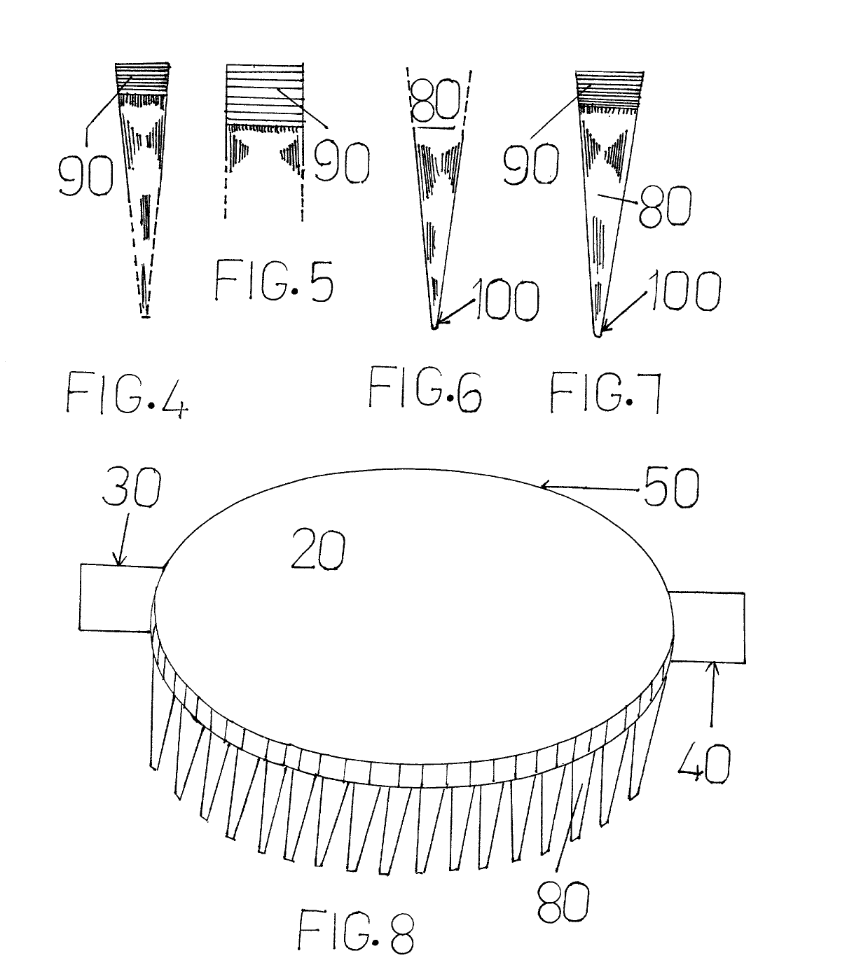

The entire figure of the nail like object 80 shown in FIG. 7. The top end of the nail like objects having a few threads 90 are screwed into the threaded holes 70 present on the bottom surface of the circularly shaped top portion 20.

The arrangement of the nail like objects 80 as shown in FIG. 8.

The dough perforator apparatus is advantageously designed such that one can turn the entire apparatus upside down and use it for perforating the dough. That is to say that the circularly shaped top portion will be the bottom part, the base of the apparatus. The nail like objects will be protruding upwards in the direction opposite to the gravity such that a plate with fixed holes containing a dough layer is placed on the pointed tips of the nail like objects in order to provide even perforations quickly.

Operation

A method of operation wherein by placing the entire apparatus 10 with the help of the two handles 30 & 40 such that the nail like objects 90 are pointing downwards in the direction of the gravity, the narrow and pointed ends 110 of the nail like objects 90 touching and penetrating through the dough layer 110. The total weight of the entire apparatus itself is sufficient enough to allow the nail like objects 90 to penetrate through the dough layer 110. For additional assurance just place users palm (s) while applying pressure gently as necessary and lift the entire apparatus with the help of the two handles. Experiments show that this additional pressure may not be necessary for perforating certain dough layers. Found out from the experiments that repetitive stress syndrome is likely to be very very less since the apparatus provides plenty of perforations in one operation.

Another method of operation of the same apparatus, wherein the entire apparatus assembly 10 is turned upside down such that the circularly shaped top portion is now the base of the entire tool. The nail like objects will be protruding upwards in the direction opposite to the gravity. Use of a plate with fixed holes allowing the nail like objects to pass through very easily. Thus perforating the dough layer can be done by placing the plate containing the dough layer to be perforated and by pushing the plate downwards and lifting the plate upwards, by holding the sides of the plate as necessary, and by lifting the plate up to remove the plate from the apparatus. However safety measures need to be token while performing this method since the nail like objects are sharp and pointed in nature by keeping the fingers away from the pointed end of the nail like objects while in operation. Such precautions may be necessary while operating very many known tools such as knives.

An example is given below with as much detail as possible. In order to provide enough air pockets in the 8″ pizza dough without damaging the dough and with less human effort.

A. Shape of the circularly shaped top portion being circular since it matches with the shape of most pizza crusts available in the market. Other shapes such as rectangular, triangular, octogonal, pentagonal, trapezoidal, or any other combination of the shapes known in the nature.

B. Size of the circularly shaped top portion being 7.5 inches.

C. Weight of the circularly shaped top portion being between 1 lb-1.5 lbs.

D. Number of nail like objects being between 30-50.

E. Size of the nail like objects being between 0.9 cm-1.5 cm. Other sizes can also be used.

F. Weight of the nail like objects being 0.5 lb-1 lb.

More or less weights can also be used.

G. Distance between the threaded holes=distance between each nail which is 0.2 inches to 1 inch.

H. Depth of the threaded holes being 0.5 inches or more depending on the size of the nail like objects.

While the invention has been described in connection with what is presently considered the most practical and preferred embodiments. It is to be understood that the invention is not limited to the disclosed embodiment(s) but, on the contrary is intended to cover various modifications, rearrangement of structures such as handles or by removing handles, any rearrangement of steps involved in the operation of the apparatus and also by turning the entire apparatus such that the top portion becomes the base portion, the base portion rests on a table, the plurality of nail like objects pointing in the direction of the gravity, and by placing a plate with plurality of holes suitably fixed allowing the tips of the fixed plurality of nail like objects into the dough layer present in the said plate with holes and by pushing the plate up and down thus providing several even perforations in the dough layer quickly and efficiently thereby avoiding too much of a repetitive syndrome to the users hand(s). equivalent arrangement included within the scope of the appended claims.

What is claimed is:

1. An apparatus for providing a plurality of perforations in a dough layer prior to baking, the apparatus comprising:
a top portion, a top portion having certain weight.
a top portion, the top portion including an upper surface of the apparatus;
a top portion, the top portion having a bottom surface;
a plurality of nail like objects supported by the bottom surface of the top portion.
a plurality of nail like objects being arranged in a fixed pattern.
Handles means to aid in lifting the tool, handles being arranged in a fixed pattern;

2. The apparatus in claim 1, wherin the weight of the top portion means to provide pressure on the nail like objects to penetrate through the dough layer.

3. The apparatus in claim 1, wherein a top portion having a bottom surface means to provide locations for the plurality of nail like objects arranged in a fixed pattern.

4. The apparatus in claim 1 wherein the entire apparatus is manually lowered directly on to the dough layer to be perforated.

5 The apparatus in claim 1, wherein the end of the nail like objects having narrow, pointed ends to provide quick penetrating capability.

6. the nail like objects in claim 1, wherein the plurality of nail like objects are arranged such that all the pointed ends of the nail like objects are pointing downwards in the direction of gravity.

7. A pair of handles in claim 1, wherein the pair of handles are attached to the circular rim of the top portion in a fixed pattern.

8. A method of creating a plurality of perforations in a dough layer using an apparatus for creating perforations, the method comprising:
a) manually lowering the entire apparatus on the dough layer with the aid of the handles such that the weight of the entire apparatus pressuring the pointed tips of the nail like objects to penetrate through the dough layer thus producing plurality of perforations in no time.
b) placing the users palm(s) on the apparatus for additional pressure such that the additional pressure being created for even perforations.
c) removing the entire apparatus from the dough layer is done by simply lifting away the entire apparatus manually.

9. The method of claim 8, wherein step (a) includes placing the entire apparatus on to the dough layer such that the plurality of nail like objects are in the same direction of the earth's gravity.
